(19) United States
(12) Patent Application Publication
(10) Pub. No.: US 2013/0057203 A1
(43) Pub. Date: Mar. 7, 2013

(54) ASSEMBLY FOR MOUNTING AN INDUCTIVE CHARGER BASE STATION TO A FURNITURE WORK SURFACE

(71) Applicants: Neil Jones, Oakville (CA); Aaron Fung, Toronto (CA)

(72) Inventors: Neil Jones, Oakville (CA); Aaron Fung, Toronto (CA)

(21) Appl. No.: 13/408,012

(22) Filed: Feb. 29, 2012

Related U.S. Application Data
(60) Provisional application No. 61/447,781, filed on Mar. 1, 2011.

(51) Int. Cl. H02J 7/00

(52) U.S. Cl. 320/108

(57) ABSTRACT

An assembly for mounting an inductive charger base station to an opening in a furniture work surface. The assembly includes a housing for securing the charger base station therein for mounting the base station within the opening, The housing includes a cover and a shoulder which locates within the opening. The cover includes an outer flange which abuts against the work surface. The housing also includes a base connected to the cover. The base includes a first clamping member extending inwardly. The housing includes an interior volume where the charger base station where the base station is located. The assembly also includes a fastening portion with an inner flange abutting against an inner face of the work surface and a second clamping member extending from the inner flange.

### PRIOR APPLICATION

This application claims the benefit of U.S. Provisional Patent Application No. 61/447,781 filed on Mar. 1, 2011 entitled “ASSEMBLY FOR MOUNTING AN INDUCTIVE CHARGER BASE STATION TO A FURNITURE WORK SURFACE”, which is incorporated by reference herein in its entirety.

### FIELD

The invention relates to an assembly for mounting an inductive charger base station to a furniture work surface.

### INTRODUCTION

Inductive charging (also referred to as wireless charging) is becoming a popular way to charge battery-powered devices, such as mobile phones and other mobile electronic devices.

### SUMMARY

According to an exemplary embodiment of the invention, there is provided an assembly for mounting an inductive charger base station into an opening in a furniture work surface. The opening has a predetermined shape. The inductive charger base station is adapted for coupling with a device. The device has an inductive charging receiver connected thereto for receiving an electrical charge from a charging coil of the base station for charging at least one battery in the device. The assembly comprises:

a housing for securing the charger base station therein, the housing adapted for mounting within the opening, the housing comprising:
a cover comprising a planar contact surface adapted for placement of the charging receiver thereon, and a shoulder extending inwardly from the contact surface, wherein the shoulder is adapted to locate within the opening, wherein a shape of the shoulder corresponds to the predetermined shape of the opening, wherein a portion of the contact surface defines an outer flange, wherein the outer flange is adapted to abut against the work surface, thereby positioning the contact surface substantially flush against the work surface; and
a base connected to the cover, wherein the base is adapted to locate within the opening, the base comprising a planar closure surface and at least one first clamping member extending inwardly from the closure surface, wherein the closure surface is spaced apart from the contact surface by at least a portion of the shoulder, wherein the contact surface, the portion of the shoulder, and the closure surface define an interior volume adapted to receive the charger base station, wherein the housing comprises a plurality of connectors to secure the charger base station within the interior volume, wherein the connectors are adapted to position the charging coil proximate to an interior face of the contact surface; and

a fastening portion comprising an inner flange adapted to abut against an inner face of the work surface and at least one second clamping member extending from the inner flange, wherein the at least one first clamping member engages the at least one second clamping member to removably secure the housing to the fastening portion.

According to another exemplary embodiment of the invention, an inductive charger assembly for mounting in an opening in a furniture work surface is provided. The opening has a predetermined shape. The charger assembly is adapted for coupling with a device having an inductive charging receiver connected thereto for receiving an electrical charge to at least one battery in the device. The assembly comprises:

a) an inductive charger base station comprising a charging coil;

b) a housing for securing the charger base station therein, the housing adapted for mounting within the opening, the housing comprising:
i) a cover comprising a planar contact surface adapted for placement of the charging receiver thereon, and a shoulder extending inwardly from the contact surface, wherein the shoulder is adapted to locate within the opening, wherein a shape of the shoulder corresponds to the predetermined shape of the opening, wherein a portion of the contact surface defines an outer flange, wherein the outer flange is adapted to abut against the outer surface 17 of the work surface, thereby positioning the contact surface substantially flush against the work surface; and
ii) a base connected to the cover, wherein the base is adapted to locate within the opening, the base comprising a planar closure surface and at least one first clamping member extending inwardly from the closure surface, wherein the closure surface is spaced apart from the contact surface by at least a portion of the shoulder, wherein the contact surface, the portion of the shoulder, and the closure surface define an interior volume, wherein the charger base station is secured in the interior volume by a plurality of connectors, wherein the charging coil is located proximate to an interior face of the contact surface; and

c) a fastening portion comprising an inner flange adapted to abut against an inner surface of the work surface and at least one second clamping member projecting from the inner flange, wherein the at least one first clamping member engages the at least one second clamping member to removably secure the housing to the fastening portion.

According to yet another exemplary embodiment of the invention, there is provided a furniture assembly with an integrated inductive charger for coupling with a device having an inductive charging receiver connected thereto for receiving an electrical charge to at least one battery in the device. The furniture assembly comprises:

a) an inductive charger base station comprising a charging coil;

b) a work surface defining an opening therethrough, the opening having a predetermined shape;

c) a housing for securing the charger base station therein, the housing located within the opening, the housing comprising:
i) a cover comprising a planar contact surface adapted for placement of the charging receiver thereon, and a shoulder extending inwardly from the contact surface, wherein the shoulder is located within the opening, wherein a shape of the shoulder corresponds to the predetermined shape of the opening, wherein a portion of the contact surface defines an outer flange, wherein the outer flange abuts against the outer surface of the work surface, wherein the contact surface is substantially flush against the work surface; and
ii) a base connected to the cover, wherein the base is located within the opening, the base comprising a planar closure surface and at least one first clamping member extending inwardly from the closure surface, wherein the closure surface is spaced apart from the contact surface by at least a portion of the shoulder, wherein the contact surface, the portion of the shoulder, and the closure surface define an interior volume, wherein the charger base station is secured in the interior volume by a plurality of connectors, wherein the charging coil is located proximate to an interior face of the contact surface; and

d) a fastening portion comprising an inner flange abutting against the inner surface of the work surface and at least one second clamping member projecting from the inner flange, wherein the at least one first clamping member engages the at least one second clamping member to removably secure the housing to the fastening portion.

According to yet another exemplary embodiment of the invention, an assembly for mounting an inductive charger base station into an opening in a furniture work surface is provided. The opening has a predetermined shape. The inductive charger base station is adapted for coupling with a device. The device has an inductive charging receiver connected thereto for receiving an electrical charge from a charging coil of the base station for charging at least one battery in the device. The assembly comprises:
a. a cover comprising a planar contact surface adapted for placement of the charging receiver thereon, and a shoulder projecting inwardly from the contact surface, wherein the shoulder is adapted to locate within the opening, wherein a shape of the shoulder corresponds to the predetermined shape of the opening, wherein a portion of the contact surface defines an outer flange, wherein the outer flange is adapted to abut against the work surface surrounding the opening, thereby positioning the contact surface substantially flush against the work surface; and
b. a base connected to the shoulder, wherein the contact surface, the shoulder and the base define an interior volume adapted to receive the charger base station, wherein the housing comprises a plurality of connectors to secure the charger base station within the interior volume, wherein the connectors are adapted to position the charging coil proximate to an interior face of the contact surface.

### DRAWINGS

For a better understanding of embodiments of the assembly described herein, and to show more clearly how they may be carried into effect, reference will be made, by way of example, to the accompanying drawings in which:

FIG. 1 is an exploded perspective view of a portion of an inductive charger assembly according to an embodiment of the present invention;

FIG. 2 is an exploded perspective view of the entire assembly according to the embodiment of FIG. 1, as well as a portion of the work surface;

FIG. 3 is a perspective view of the assembly mounted in a work surface according to an embodiment of the present invention; and

FIG. 4 is an exploded perspective view of an alternative embodiment of an inductive charger assembly.

### DESCRIPTION OF VARIOUS EMBODIMENTS

Various apparatuses or processes will be described below to provide an example of each claimed invention. No example described below limits any claimed invention and any claimed invention may cover processes or apparatuses that are not described below. The claimed inventions are not limited to apparatuses or processes having all of the features of any one apparatus or process described below or to features common to multiple or all of the apparatuses described below. It is possible that an apparatus or process described below is not an embodiment of any claimed invention. Applicant reserves the right to claim such apparatuses or processes in other applications.

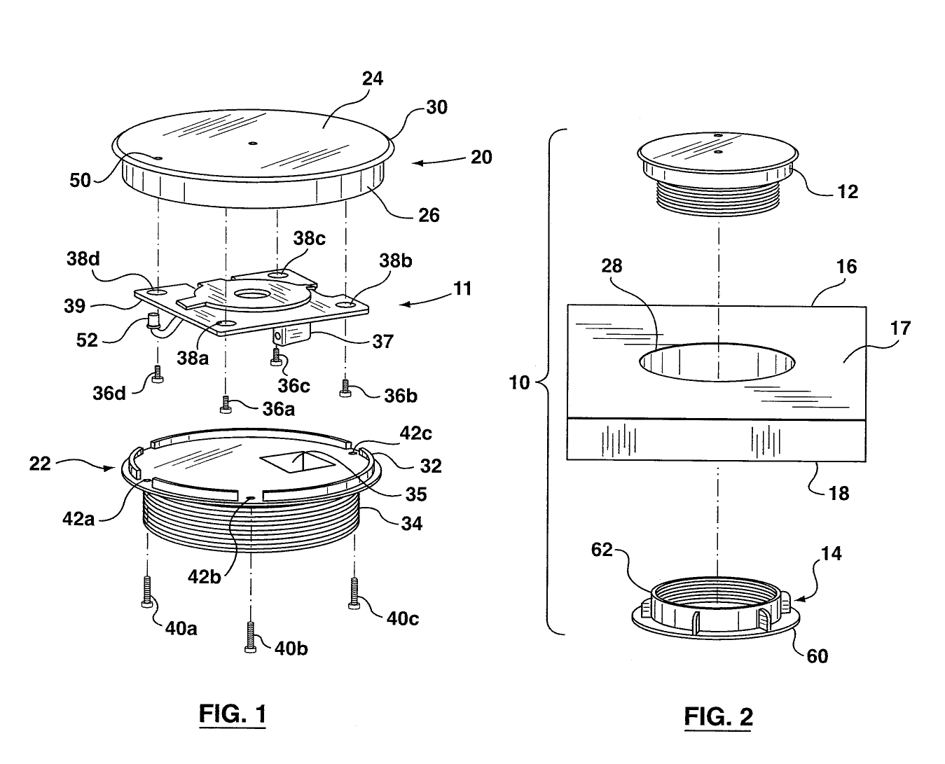

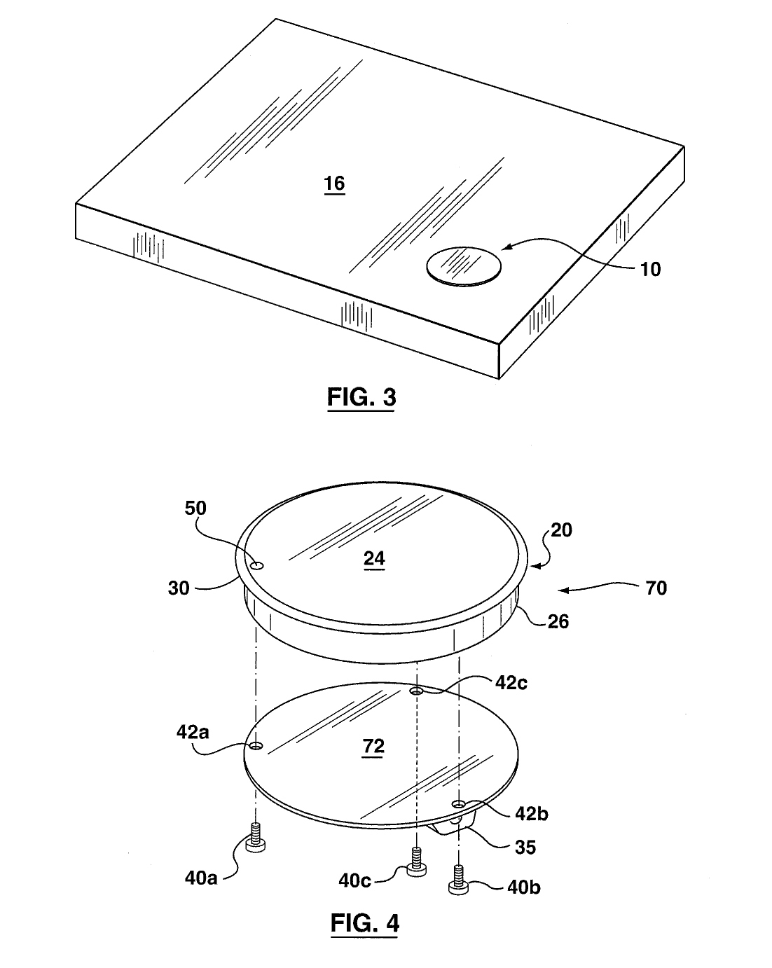

FIGS. 1-3 show an assembly 10 for mounting an inductive charger base station 11 to a work surface 16. The inductive charger base station charges a device powered by a battery (such as, for example, a mobile phone, smart phone, or other mobile computing device) which is equipped with an inductive charging receiver. The device, battery and charging receiver are not shown. The charger base station and inductive charging receiver are commercially available, for example, from Powermat USA, LLC.

Referring to FIG. 2, the assembly 10 includes a housing 12 and a fastening portion 14. In one embodiment, the assembly may be provided as part of a furniture system which includes the work surface 16 (such as a desk, table, or the like). In another embodiment, the assembly 10 may be provided independently of the work surface 16.

Referring now to FIG. 1, the housing 12 includes a cover 20 and a base 22. The cover 20 includes a planar contact surface 24 on which the inductive charging receiver of the device is placed. Preferably, the planar contact surface 24 is a circular surface. A shoulder 26 extends inwardly from the contact surface 24. As used herein “inwardly” means a direction from an outer surface 17 of work surface 16 to an inner surface 18 of the work surface. In a horizontally-oriented work surface, the outer surface is the top surface, the inner surface is the bottom surface, and “inward” means downward.

Referring now to FIGS. 1 and 2, preferably, the shoulder 26 has an annular shape which locates into a preferably circular opening 28 in the work surface 16. Those skilled in the art will understand that the opening 28 in the work surface may be any suitable shape. Preferably, the shape of the shoulder 26 corresponds to the shape of the opening 28 in the work surface. The portion of the contact surface 24 outside the shoulder 26 defines an outer flange 30. Preferably, the outer flange 30 has a greater circumference than the opening 28 in the work surface 16.

Referring now to FIG. 1, the base 22 is connected to the cover 20 and locates within the opening 28. The base 22 includes a planar closure surface 32 which abuts against the shoulder 26 and is spaced apart from the contact surface 24. A first clamping member 34 extends inwardly from the closure surface 32. Preferably, the first clamping member 34 is an externally threaded ring. The closure surface 32 includes a pocket 35 in which a power supply jack 37 for the charger station 11 is located.

The contact surface 24, shoulder 26, and closure surface 32 define an interior volume in which the charger station 11 is received. Preferably, the charger station 11 is secured to the underside of the contact surface 24 by first threaded fasteners 36a-d which pass through holes 38a-d in charger station 11 and are secured within first internally threaded posts (not shown) preferably integrally molded to the underside of contact surface 24. When the charger station 11 is secured to the housing 12, the charging coil 39 of the charger station 11 preferably abuts against the underside of the contact surface 24. The base 22 is secured to the cover 20 by second fasteners 40a-c which pass through corresponding holes 42a-c and locate into second internally threaded posts (not shown) preferably integrally molded to the underside of contact surface 24.

Continuing to refer to FIG. 1, an additional opening 50 may be provided in the contact surface 24 to accommodate and LED 52 connected to the charger station 11. The LED 52 may illuminate when the device is charging.

Referring now to FIG. 2, the fastening portion 14 includes an inner flange 60 from which a second clamping member 62 extends preferably outwardly. Preferably, the inner flange 60 has a greater circumference than the opening 28 in the work surface 16. In the illustrated embodiment, the second clamping member 62 is an internally threaded ring extending outwardly from the inner flange 60. However, those skilled in the art will understand that the orientation of the inner flange 60 and the second clamping member 62 may be reversed (i.e. the internally threaded ring 62 may extend inwardly from the inner flange 60). One or more ribs 64 extend radially from the threaded ring 62 to provide structural support for the inner flange 60.

In operation, the housing 12 containing the charger base station 11 is inserted into the opening 28 in the work surface 16, such that the outer flange 30 rests on the work surface 16 around the edge of the opening 28. The externally threaded ring 34 passes through the opening and projects from the inner surface 18 of the work surface 16. The fastening portion 14 is then attached by screwing the internally threaded ring 62 on to the externally threaded ring 34 of the housing 12 until the inner flange 60 abuts against an inner surface 18 of the work surface 16. When the assembly 10 is mounted on the work surface 16, an appearance is created that the contact surface 24 is substantially flush with the work surface due preferably to the small thickness of the contact surface 24.

FIG. 4 illustrates an inductive charger assembly 70 according to an alternative embodiment of the invention. In FIG. 4, like parts have been given like reference numbers. The assembly 70 is particularly suitable for a horizontally oriented work surface. The assembly 70 includes a cover 20 and a base plate 72. The cover 20 includes a planar contact surface 24 on which the inductive charging receiver of the device is placed. Preferably, the planar contact surface 24 is a circular surface.

A shoulder 26 extends downwardly from the contact surface 24. The shoulder 26 has an annular shape which locates into a preferably circular opening 28 in the work surface 16. Those skilled in the art will understand that the opening 28 in the work surface may be any suitable shape. Preferably, the shape of the shoulder 26 corresponds to the shape of the opening 28 in the work surface. The portion of the contact surface 24 outside the shoulder 26 defines an outer flange 30. Preferably, the outer flange 30 has a greater circumference than the opening 28 in the work surface 16.

The base plate 72 is connected to the cover 20 and locates within the opening 28. The base plate 72 includes a pocket 35 in which a power supply jack 37 (not shown in FIG. 4) for the charger station 11 (not shown in FIG. 4) is located.

The contact surface 24, shoulder 26, and base plate 72 define an interior volume where the charger station 11 is received. Preferably, the charger station 11 is secured to the underside of the contact surface 24 in the same manner as shown for the embodiment for FIGS. 1-3. The base plate 72 is secured to the cover 20 by fasteners 40a-c which pass through corresponding holes 42a-c and locate into second internally threaded posts (not shown) preferably integrally molded to the underside of contact surface 24.

Continuing to refer to FIG. 4, an additional opening 50 may be provided in the contact surface 24 to accommodate an LED 52 (not shown in FIG. 4) connected to the charger station 11. The LED 52 may illuminate when the device is charging.

In operation, the assembly 70 may be placed into an opening 28 of a preferably horizontal work surface 16. The outer flange 30 overlays the edge of the opening 28, such that the assembly is positioned in place by the force of gravity.

The assembly 70 may be mounted into a non-horizontal work surface by making clearance between the shoulder 26 and opening 28 sufficiently small such that the assembly 70 is held in place by an interference fit.

While the above description provides examples of the embodiments, it will be appreciated that some features and/or functions of the described embodiments are susceptible to modification without departing from the spirit and principles of operation of the described embodiments. Accordingly, what has been described above has been intended to be illustrative of the invention and non-limiting and it will be understood by persons skilled in the art that other variants and modifications may be made without departing from the scope of the invention as defined in the claims appended hereto.

1. An assembly for mounting an inductive charger base station within an opening in a furniture work surface, the opening having a predetermined shape, the inductive charger base station adapted for coupling with a device, the device having an inductive charging receiver connected thereto for receiving an electrical charge from a charging coil of the base station for charging at least one battery in the device, the assembly comprising:
a) a housing for securing the charger base station therein, the housing adapted for mounting within the opening, the housing comprising:
i) a cover comprising a planar contact surface adapted for placement of the charging receiver thereon, and a shoulder extending inwardly from the contact surface, wherein the shoulder is adapted to locate within the opening, wherein a shape of the shoulder corresponds to the predetermined shape of the opening, wherein a portion of the contact surface defines an outer flange, wherein the outer flange is adapted to abut against the work surface, thereby positioning the contact surface substantially flush against the work surface; and
ii) a base connected to the cover, wherein the base is adapted to locate within the opening, the base comprising a planar closure surface and at least one first clamping member extending inwardly from the closure surface, wherein the closure surface is spaced apart from the contact surface by at least a portion of the shoulder, wherein the contact surface, the portion of the shoulder, and the closure surface define an interior volume adapted to receive the charger base station, wherein the housing comprises a plurality of connectors to secure the charger base station within the interior volume, wherein the connectors are adapted to position the charging coil proximate to an interior face of the contact surface; and
b) a fastening portion comprising an inner flange adapted to abut against an inner face of the work surface and at least one second clamping member extending from the inner flange, wherein the at least one first clamping member engages the at least one second clamping member to removably secure the housing to the fastening portion.

2. The assembly of claim 1, wherein the predetermined shape of the opening is a generally circular shape, wherein the shoulder has a generally annular shape and the closure surface has a generally circular shape.

3. The assembly of claim 2, wherein the first and second clamping members each comprise threaded rings adapted to threadably engage each other, wherein one of the first and second clamping members comprises an externally threaded ring and the other of the first and second clamping members comprises an internally threaded ring, wherein the externally threaded ring is configured to threadably engage the internally threaded ring to removably secure the assembly to the furniture work surface.

4. The assembly of claim 3, wherein the first clamping member comprises the externally threaded ring projecting inwardly from the closure surface of the base, wherein the second clamping member comprises the internally threaded ring extending outwardly from the inner flange of the fastening portion.

5. The assembly of claim 4, wherein the fastening portion comprises a plurality of ribs located around an outer circumference of the internally threaded ring.

6. The assembly of claim 5, wherein the plurality of ribs are integral with the internally threaded ring and the inner flange.

7. The assembly of claim 5, wherein the outer flange of the cover extends radially outward from the shoulder.

8. The assembly of claim 1, wherein the contact surface defines an additional opening, wherein a LED is located in the additional opening, wherein the LED is adapted to illuminate when the device is charging.

9. The assembly of claim 1, wherein the base is secured to the cover by a plurality of fasteners.

10. The assembly of claim 1, wherein the closure surface defines a pocket therein to receive a power supply jack for the inductive charger base station.

11. An inductive charger assembly for mounting in an opening in a furniture work surface, the opening having a predetermined shape, the charger assembly adapted for coupling with a device having an inductive charging receiver connected thereto for receiving an electrical charge to at least one battery in the device, the assembly comprising:
a) an inductive charger base station comprising a charging coil;
b) a housing for securing the charger base station therein, the housing adapted for mounting within the opening, the housing comprising:
i) a cover comprising a planar contact surface adapted for placement of the charging receiver thereon, and a shoulder extending inwardly from the contact surface, wherein the shoulder is adapted to locate within the opening, wherein a shape of the shoulder corresponds to the predetermined shape of the opening, wherein a portion of the contact surface defines an outer flange, wherein the outer flange is adapted to abut against the outer surface of the work surface, thereby positioning the contact surface substantially flush against the work surface; and
ii) a base connected to the cover, wherein the base is adapted to locate within the opening, the base comprising a planar closure surface and at least one first clamping member extending inwardly from the closure surface, wherein the closure surface is spaced apart from the contact surface by at least a portion of the shoulder, wherein the contact surface, the portion of the shoulder, and the closure surface define an interior volume, wherein the charger base station is secured in the interior volume by a plurality of connectors, wherein the charging coil is located proximate to an interior face of the contact surface; and
c) a fastening portion comprising an inner flange adapted to abut against an inner surface of the work surface and at least one second clamping member projecting from the inner flange, wherein the at least one first clamping member engages the at least one second clamping member to removably secure the housing to the fastening portion.

12. The assembly of claim 11, wherein the predetermined shape of the opening is a generally circular shape, wherein the shoulder has a generally annular shape and the closure surface has a generally circular shape.

13. The assembly of claim 12, wherein the first and second clamping members each comprise threaded rings adapted to threadably engage each other, wherein one of the first and second clamping members comprises an externally threaded ring and the other of the first and second clamping members comprises an internally threaded ring, wherein the externally threaded ring is configured to threadably engage the internally threaded ring to removably secure the assembly to the furniture work surface.

14. The assembly of claim 13, wherein the first clamping member comprises the externally threaded ring projecting inwardly from the closure surface of the base, wherein the second clamping member comprises the internally threaded ring extending outwardly from the inner flange of the fastening portion.

15. The assembly of claim 14, wherein the fastening portion comprises a plurality of ribs located around an outer circumference of the internally threaded ring.

16. The assembly of claim 15, wherein the outer flange of the cover extends radially outward from the shoulder.

17. The assembly of claim 11, wherein the contact surface defines an additional opening, wherein a LED is located in the additional opening, wherein the LED is adapted to illuminate when the device is charging.

18. The assembly of claim 11, wherein the closure surface defines a pocket therein to receive a power supply jack for the inductive charger base station.

19. A furniture assembly with an integrated inductive charger for coupling with a device having an inductive charging receiver connected thereto for receiving an electrical charge to at least one battery in the device, the furniture assembly comprising:
a) an inductive charger base station comprising a charging coil;
b) a work surface defining an opening therethrough, the opening having a predetermined shape;
c) a housing for securing the charger base station therein, the housing located within the opening, the housing comprising:
i) a cover comprising a planar contact surface adapted for placement of the charging receiver thereon, and a shoulder extending inwardly from the contact surface, wherein the shoulder is located within the opening, wherein a shape of the shoulder corresponds to the predetermined shape of the opening, wherein a portion of the contact surface defines an outer flange, wherein the outer flange abuts against the outer surface of the work surface, wherein the contact surface is substantially flush against the work surface; and
ii) a base connected to the cover, wherein the base is located within the opening, the base comprising a planar closure surface and at least one first clamping member extending inwardly from the closure surface, wherein the closure surface is spaced apart from the contact surface by at least a portion of the shoulder, wherein the contact surface, the portion of the shoulder, and the closure surface define an interior volume, wherein the charger base station is secured in the interior volume by a plurality of connectors, wherein the charging coil is located proximate to an interior face of the contact surface; and
d) a fastening portion comprising an inner flange abutting against the inner surface of the work surface and at least one second clamping member projecting from the inner flange, wherein the at least one first clamping member engages the at least one second clamping member to removably secure the housing to the fastening portion.

20. The assembly of claim 19, wherein the predetermined shape of the opening is a generally circular shape, wherein the shoulder has a generally annular shape and the closure surface has a generally circular shape.

21. The assembly of claim 20, wherein the first and second clamping members each comprise threaded rings adapted to threadably engage each other, wherein one of the first and second clamping members comprises an externally threaded ring and the other of the first and second clamping members comprises an internally threaded ring, wherein the externally threaded ring is configured to threadably engage the internally threaded ring to removably secure the assembly to the furniture work surface.

22. The assembly of claim 21, wherein the first clamping member comprises the externally threaded ring projecting inwardly from the closure surface of the base, wherein the second clamping member comprises the internally threaded ring extending outwardly from the inner flange of the fastening portion.

23. The assembly of claim 19, wherein the contact surface defines an additional opening, wherein a LED is located in the additional opening, wherein the LED is adapted to illuminate when the device is charging.

24. An assembly for mounting an inductive charger base station within an opening in a furniture work surface, the opening having a predetermined shape, the inductive charger base station adapted for coupling with a device, the device having an inductive charging receiver connected thereto for receiving an electrical charge from a charging coil of the base station for charging at least one battery in the device, the assembly comprising:
a) a cover comprising a planar contact surface adapted for placement of the charging receiver thereon, and a shoulder projecting inwardly from the contact surface, wherein the shoulder is adapted to locate within the opening, wherein a shape of the shoulder corresponds to the predetermined shape of the opening, wherein a portion of the contact surface defines an outer flange, wherein the outer flange is adapted to abut against the work surface surrounding the opening, thereby positioning the contact surface substantially flush against the work surface; and
b) a base connected to the shoulder, wherein the contact surface, the shoulder and the base define an interior volume adapted to receive the charger base station, wherein the housing comprises a plurality of connectors to secure the charger base station within the interior volume, wherein the connectors are adapted to position the charging coil proximate to an interior face of the contact surface.
